(19) United States
(12) Patent Application Publication
(10) Pub. No.: US 2007/0217395 A1
(43) Pub. Date: Sep. 20, 2007

(54) Method For Checking Data Transfer Authorization In A Data Mobile Network

(76) Inventors: Olaf Böhme, Berlin (DE); Uwe Foll, Falkensee (DE); Thomas Hickethier, Berlin (DE)

Correspondence Address: STAAS & HALSEY LLP, SUITE 700, 1201 NEW YORK AVENUE, N.W., WASHINGTON, DC, 20005, US

(21) Appl. No.: 10/586,907

(22) PCT Filed: Jan. 11, 2005
(86) PCT No.: PCT/DE05/00062

§ 371 Date: Apr. 11, 2007

(30) Foreign Application Priority Data
Jan. 22, 2004 (DE) 10 2004 004 527.5

(51) Int. Cl. H04L 12/66

(52) U.S. Cl. 370/352

(57) ABSTRACT

Data transfer between a first subscriber having a first IP address and a second subscriber having a second IP address via a tariff-reduced data connection in a data mobile radio network is controlled by a functional unit in the data mobile radio network examining the authorization of the subscribers using the IP addresses of the subscribers involved in the data transfer.

The present invention relates to a method of authorization control for data transfer in a data mobile network, in particular a GPRS network. In order to avoid charge metering for the use of purely transport resources, certain data channels, in the case of a GPRS network special GPRS contexts, are set to “nonchargeable” or “reduced-charge” by a corresponding network operator. The GPRS contexts are provided with specific identifiers by configuration by the operator and are therefore treated specially for charging purposes. For all the data transferred via one of these contexts, no charges are therefore collected by the data mobile network from the subscribers involved in the data transfer. For example, for so-called IMS applications, i.e. IP Multimedia Subsystem applications, charges arising are collected in separate network functional elements of the IMS, such as in a so-called “Call Session Control Function” (CSCF), said network functional elements being integral parts of the IMS. For the contexts used by the IMS, a special IMS identifier for the context has been standardized. In order to avoid double charging, all the data of such an IMS application is sent via a nonchargeable access network node or APN (Access Point Name) of the data mobile network. In general for IP connections via GPRS, GTP tunnels are set up from a first user as far as the GPRS gateway to the actual IP network. These tunnels, also known as PDP contexts, constitute chargeable entities, are recorded as such and thus can also be designated as nonchargeable according to purpose. However, the actual data connection does not end at this gateway but continues to a second user.

The resulting technical problem arises when a subscriber uses a nonchargeable context of this kind for the transfer of further data not subject to IMS charge metering. To do this, a corresponding first user could, for example, communicate the IP address of the corresponding context to a download computer, i.e. a computer within an IP network which provides data which can be downloaded by users to their terminal, as a second user, so that said computer can send data on a defined port, i.e. additional address information, bypassing the chargeable network functional element such as the so-called CSCF of the IMS, to the subscriber or more specifically to a mobile station of the subscriber. That is to say, the first subscriber is addressed from the IP network not via his generally temporary IP address, but via the IP address assigned to the PDP context. As any thereby accruing transmission volume is not recorded in the IP network, data could be transmitted free of charge by this means. In short, this means that a first subscriber who has set up a PDP context classified as nonchargeable to a second subscriber can be reached by another second subscriber, an unauthorized subscriber, via the same PDP context. This in turn means that data traffic that should not be classified as nonchargeable can take place from/to the other second subscriber, i.e. the unauthorized subscriber, via a PDP context classified as nonchargeable.

One object of the present invention was to provide a method for preventing data bypassing a chargeable entity from being able to be transmitted in a data mobile network.

This object is achieved by the inventive method according to Claim 1. Further advantageous embodiments of the inventive method are set forth in the sub-claims.

According to Claim 1 there is presented a method for checking authorization for data transfer in a data mobile network such as a GPRS network between a first subscriber with a first IP address and a second subscriber with a second IP address over a reduced-charge data connection, in particular a reduced-charge GPRS connection, wherein a functional unit (GEF) in the data mobile network (GPRS network) is provided which uses the IP addresses of the subscribers involved in the data transfer to check the authorization of said subscribers.

In a particularly preferred embodiment of the method according to the invention, the authorization of the subscribers is checked when setting up a “reduced-charge” data tunnel used for data transfer such as, for example, a so-called PDP context from one of the subscribers via a network gateway node, such as, in the case of a GPRS network, a GGSN (Gateway GPRS Support Node) of the data mobile network, i.e. GPRS network, to another subscriber. In this process the IP addresses of the subscribers participating in the data transfer in question for which the data tunnel is to be set up are ascertained and evaluated in respect of the subscribers' authorization to use the data tunnel designated as “reduced-charge”. An evaluation of this kind is performed, for example, by comparing the ascertained IP addresses with IP addresses contained in a list stored in the functional unit, said list containing all the IP addresses entitled or authorized to use the data tunnel designated as “reduced-charge”. The list stored in the functional unit can preferably be dynamically modified. Any such a modification can be carried out e.g. on the part of the network operator.

In a particularly preferred embodiment of the method according to the invention, the functional unit is incorporated in the network gateway node of the data mobile network. This means that, in the case of a GPRS network, the functional unit is an integral part of the GGSN.

In another preferred embodiment of the method according to the invention, the functional unit, also known as a charge metering function (GEF), records the data volume of every data transfer over the data (GPRS) connection, i.e. via the data tunnel designated as “reduced-charge”, according to the IP addresses involved in the data transfer. Data volume recording performed in this way depending on the IP addresses involved in the data transfer allows differentiation and separation of the authorized and unauthorized IP addresses and appropriate charging for the use of the data tunnel by the unauthorized IP addresses.

In another preferred embodiment of the method according to the invention, the functional unit, i.e. the charge metering function (GEF), is linked with a control function or more precisely a charge control function (GRF). Via this charge control function the functional unit (GEF) receives instructions as to how an upcoming unauthorized data transfer is to be handled, for example. An upcoming unauthorized data transfer is taken to mean a data transfer which is to take place via the data tunnel designated as “reduced-charge” whereby at least one of the subscribers involved in the data transfer with his IP address is not authorized to use said data tunnel.

The IP addresses of the subscribers authorized to participate in a data transfer over the reduced-charge, preferably nonchargeable data (GPRS) connection, i.e. via the correspondingly designated data tunnel, are preferably not stored in the functional unit (GEF) itself, but in the control function (GRF).

Preferably an upcoming unauthorized data transfer is already blocked beforehand, i.e. no data can be transmitted. As already described, the unauthorized data transfer is detected using the IP addresses involved. Incoming data packets are then rejected and an error message can be sent to the sender, thereby preventing a reduced-charge or nonchargeable data connection, i.e. a corresponding data tunnel, from being used for purposes other than intended.

The method according to the invention can be used e.g. for so-called IMS applications already mentioned. If a subscriber is logged into an IMS (IP Multimedia Subsystem) and can therefore transfer data from IMS applications to the corresponding subscriber, an obvious solution is for this data transfer to be controlled and monitored by the IMS. For this purpose the control function (GRF) is dynamically controlled by the IMS, in particular by a control unit disposed therein, a so-called CSCF (Call Session Control Function). The control function receives information from the CSCF as to which subscribers are authorized to use a corresponding PDP context, i.e. a corresponding data tunnel, for transferring data. The subscribers are stored along with their IP addresses. If a subscriber registered with the IMS sets up a connection by means of the IMS to another subscriber registered with the IMS, the charges arising from this connection can be recorded by the IMS, preferably in a corresponding CSCF, and billed to the subscribers accordingly. This is described in greater detail in the 3GPP TS 32.260 specification. As mentioned above, in order to prevent repeat charging for the same connection in the data mobile network, charge metering is switched off in the data mobile network e.g. via a specially selected access network node, a specially selected APN (Access Point Name). If after data transfer involving the IMS the subscriber communicates his IP address, i.e. the IP address of the already set-up data tunnel, to another subscriber registered with the IMS, i.e. a corresponding communications terminal such as a download computer, the method according to the invention eliminates the possibility of charge metering being bypassed for data transfer between the other communications terminal and the subscriber. The functional unit according to the invention or more precisely the charge metering function (GEF) can use the IP address of the communications terminal to determine that the data is coming from an unauthorized IP address, namely from the communications terminal not registered with the IMS. Because of this, either every data transfer is blocked or the data volume of the transferred data is recorded and billed to the corresponding customer. The functional unit, i.e. the charge metering function (GRF), is informed by the control function as to which rules are to be applied to unauthorized data transfers of this kind, it being possible to allow the data transfer and record and bill the data volume of the transferred data or to block a data transfer of this kind.

The applicable rules are preferably dynamically controlled by the IMS. This means that the relevant rules are not static but can be flexibly modified. The rules are preferably controlled by the IMS element, the CSCF.

Further advantages of the present invention will now be explained in greater detail with reference to the accompanying drawings in which:

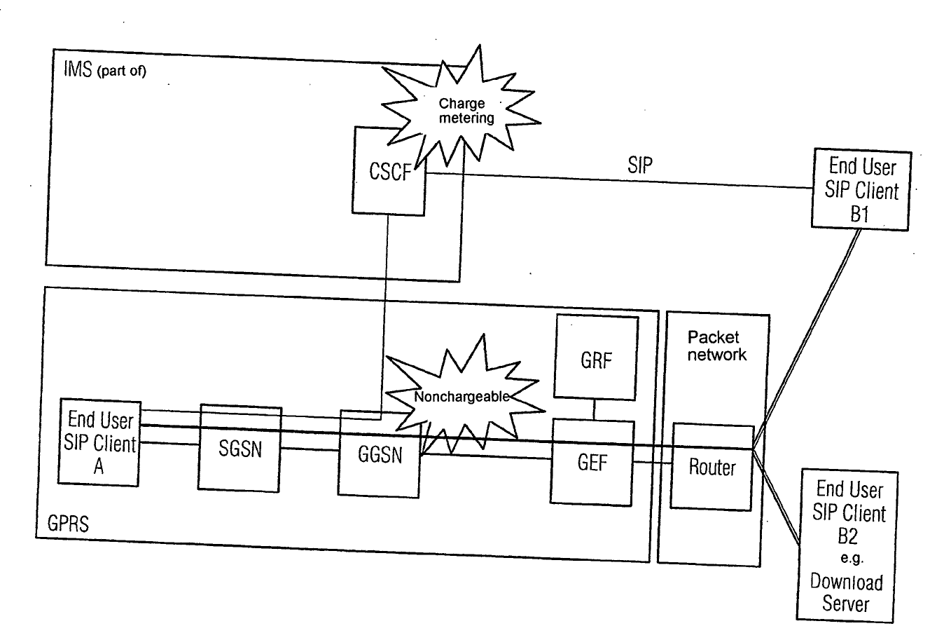

FIG. 1 schematically illustrates a sequence of an implementation of the method according to the invention.

FIG. 1 schematically illustrates a sequence of an implementation of the method according to the invention, showing the networks involved in the sequence with their corresponding network elements. An IMS (IP Multimedia Subsystem) is illustrated having a network element, namely a control unit, a so-called CSCF (Call Session Control Function). Also shown is a data mobile network, namely a GPRS network with a service network node, a so-called SGSN (Service GPRS Support Node), an access network node, a so-called GGSN (Gateway GPRS Support Node), a functional unit according to the invention, i.e. a charge metering function GEF and a control function according to the invention, i.e. a charge control function GRF. A packet network with a router is additionally shown. Also shown are three subscribers denoted here as “End User SIP (session initial protocol) Clients”. A first subscriber A with a first IP address is registered with the GPRS network. He is at the same time an IMS subscriber and uses the IMS to set up a data connection to a second subscriber B1 having a second IP address. The second subscriber B1 is also an IMS subscriber. As a result of this, a data tunnel characterized as “nonchargeable” is set up for a data transfer to be effected between the first subscriber A and the second subscriber B1 in the GPRS network. Data transmitted via said data tunnel from subscriber A to subscriber B1 and vice versa is therefore not metered for charging in the GPRS network. Charges accordingly arising for this data are recorded in the IMS. The precise sequence is set out and explained in the 3GPP TS 32.260 specification. Within the GPRS network the data tunnel now also passes the functional GEF which is linked to the control function GRF. In the GEF, the IP addresses of the subscribers A and B1 involved in the data transfer via the data tunnel designated as “nonchargeable” are ascertained and checked for their authorization to use the data tunnel. In the GRF linked to the GEF and acting in conjunction with same, a list of the authorized IP addresses is stored so that, by comparing the IP addresses of subscriber A and B1 with the stored IP addresses, a check can be carried out very quickly. If after a data transfer between subscribers A and B1 the subscriber A communicates his IP address, or rather the IP address assigned to the data tunnel set up between A and B1 via which the subscriber A is addressable, to the additional third subscriber B2 with a third IP address, the subscriber B2, possibly a download computer, for example, can initially send data to the IP address of the subscriber A, which means that subscriber B2 is using the data tunnel designated as “nonchargeable”. As charge metering for this data tunnel is switched off, initially no charges are recorded for the data transferred over same. In addition, the IMS is not informed about any data transfer between A and B2, as subscriber B2 is not an IMS subscriber, which means that no charges can be recorded by the IMS either. However, the GEF ascertains in conjunction with the GRF that the IP address of subscriber B2 is not in the list of authorized IP addresses. The GRF now specifies a rule or instruction for the GEF as to how such a data transfer between A and B2 is to be handled. The rule can in turn be dynamically controlled by the IMS or rather by the CSCF. The rule may signify, for example, that a data transfer between subscribers A and B2 using the data tunnel designated as “nonchargeable” is blocked, i.e. no data can be transferred. Alternatively, the rule may also specify that, for a data transfer between subscribers A and B2, the volume of data transferred is metered and billed to one of the users, i.e. either A or B2.

1-8. (canceled)

9. A method for checking authorization for a nonchargeable data transfer over a reduced-charge data connection in a data mobile network between a first subscriber with a first Internet protocol address and a second subscriber with a second first Internet protocol address, comprising:
checking, in a functional unit in the data mobile network, authorization of the subscribers to participate in the nonchargeable data transfer using the first and second Internet protocol addresses of the first and second subscribers.

10. A method according to claim 9, wherein said checking of the authorization is performed when setting up a data tunnel used for the nonchargeable data transfer between the first and second subscribers via a network gateway node of the data mobile network.

11. A method according to claim 10, wherein the functional unit is incorporated in a network access node of the data mobile network.

12. A method according to claim 11, wherein the functional unit records data volume of each data transfer via the reduced-charge data connection depending on Internet protocol addresses involved.

13. A method according to claim 12, wherein the functional unit is linked to a control function which contains rules in respect of handling data transfers depending on the Internet protocol addresses of all subscribers involved in each data transfer, and
further comprising receiving at the functional unit a rule as to how an upcoming data transfer is to be handled.

14. A method according to claim 13, further comprising storing the Internet protocol addresses of the first and second subscribers authorized to use the reduced-charge data connection in the control function.

15. A method according to claim 14, further comprising blocking the upcoming data transfer over the reduced-charge data connection if all of the subscribers involved in the upcoming data transfer are not authorized to use the reduced-charge data connection.

16. A method according to claim 15, further comprising dynamically controlling the rules stored in the control function by an Internet protocol Multimedia Subsystem.

17. A method according to claim 16, further comprising dynamically controlling the rules stored in the control function by a Call Session Control Function.
